(19) United States
(12) Patent Application Publication
(10) Pub. No.: US 2018/0040090 A1
(43) Pub. Date: Feb. 8, 2018

(54) ROAD HEALTH (POTHOLE) DETECTION OVER WIRELESS INFRASTRUCTURE

(71) Applicant: Panasonic Automotive Systems Company of America, Division of Panasonic Corporation of North America, Peachtree City, GA (US)

(72) Inventors: HANS ALFRED TROEMEL, JR., SHARPSBURG, GA (US); MICHAEL ROBERT STELTS, WESTFIELD, IN (US)

(73) Assignee: Panasonic Automatic Systems Company of America, Division of Panasonic Corporation of North America

(21) Appl. No.: 15/662,753

(22) Filed: Jul. 28, 2017

Related U.S. Application Data
(60) Provisional application No. 62/370,971, filed on Aug. 4, 2016.

(51) Int. Cl. G06Q 50/26; G06Q 10/00; G08G 1/127; G07C 5/00; B60W 40/06; B60W 40/068

(52) U.S. Cl. CPC G06Q 50/265; B60W 40/06; B60W 40/068; G08G 1/127; G07C 5/008; G06Q 10/20; B60W 2400/00; B60W 2550/402

(57) ABSTRACT

A motor vehicle includes a road condition sensor detecting a hazardous condition of a road on which the motor vehicle is traveling. A global positioning system detects a global position of the motor vehicle. An electronic processor receives a road condition signal from the road condition sensor. The road condition signal is indicative of the hazardous condition of the road on which the motor vehicle is traveling. The electronic processor receives a global position signal from the global positioning sensor. The global position signal is indicative of the global position of the motor vehicle. The electronic processor causes a road hazard signal to be wirelessly transmitted to an entity disposed remote from the motor vehicle. The road hazard signal is indicative of the hazardous condition of the road on which the motor vehicle is traveling and of a global position at which the hazardous condition of the road exists.

### CROSS-REFERENCE TO RELATED APPLICATION

This application claims benefit of U.S. Provisional Application No. 62/370,971 filed on Aug. 4, 2016, which the disclosure of which is hereby incorporated by reference in its entirety for all purposes.

### FIELD OF THE INVENTION

The disclosure relates to an arrangement for protecting motor vehicles from potholes, icy roads, and other hazardous road conditions.

### BACKGROUND OF THE INVENTION

Roads are known to develop hazardous conditions, such as potholes, layers of ice thereon, or some type of debris laying on the road, such as roadkill. These hazardous conditions may cause damage to the vehicles and/or vehicle collisions as the vehicles lose traction and control. Currently, the usual way in which such hazardous conditions are rectified is that a driver who encounters the conditions reports them via telephone or email to a governmental entity who may then fill the pothole, put salt on the icy road, or remove the debris, for example. This type of reporting is unreliable, time-consuming, and late in coming, however, and many additional vehicles may suffer through the hazardous conditions before a correction is finally made.

### SUMMARY

The present invention may include a vehicle including a sensor for detecting a road hazard and a transceiver for wirelessly reporting the hazard to a governmental entity. The sensor may be an accelerometer for detecting the jarring of the vehicle when hitting a pothole or when hitting an object lying in the road. The sensor could also be a traction sensor for detecting icy road conditions. An electronic processor may analyze the output signal of the accelerometer to recognize the characteristic of a pothole or other object being hit by a tire of the vehicle. In response to detecting the road hazard, the processor may wirelessly report the hazard to a central authority, such as a governmental entity. The governmental entity may respond by displaying a warning message on an electronic billboard at a point in the road before the hazard, wirelessly broadcasting a warning message, and/or by dispatching maintenance personnel to rectify the hazard.

In one embodiment, the invention comprises a motor vehicle including a road condition sensor detecting a hazardous condition of a road on which the motor vehicle is traveling. A global positioning system detects a global position of the motor vehicle. An electronic processor is communicatively coupled to the road condition sensor and to the global positioning sensor. The electronic processor receives a road condition signal from the road condition sensor. The road condition signal is indicative of the hazardous condition of the road on which the motor vehicle is traveling. The electronic processor receives a global position signal from the global positioning sensor. The global position signal is indicative of the global position of the motor vehicle. The electronic processor causes a road hazard signal to be wirelessly transmitted to an entity disposed remote from the motor vehicle. The road hazard signal is indicative of the hazardous condition of the road on which the motor vehicle is traveling and of a global position at which the hazardous condition of the road exists.

In another embodiment, the invention comprises a method of operating a motor vehicle, including detecting a hazardous condition of a road on which the motor vehicle is traveling. A global position of the motor vehicle is sensed. A road condition signal is transmitted. The road condition signal is indicative of the hazardous condition of the road on which the motor vehicle is traveling. A global position signal is transmitted. The global position signal is indicative of the global position of the motor vehicle. A road hazard signal is caused to be wirelessly transmitted from the motor vehicle to an entity disposed remote from the motor vehicle. The road hazard signal is indicative of the hazardous condition of the road on which the motor vehicle is traveling and of a global position at which the hazardous condition of the road exists.

In yet another embodiment, the invention comprises a motor vehicle including a road condition sensor detecting a hazardous condition of a road on which the motor vehicle is traveling. A global positioning system detects a global position of the motor vehicle. An electronic processor is communicatively coupled to the road condition sensor and to the global positioning sensor. The electronic processor receives a road condition signal from the road condition sensor. The road condition signal is indicative of the hazardous condition of the road on which the motor vehicle is traveling. The electronic processor receives a global position signal from the global positioning sensor. The global position signal is indicative of the global position of the motor vehicle. The electronic processor causes road hazard data to be wirelessly transmitted to an entity disposed remote from the motor vehicle. The road hazard data is indicative of the hazardous condition of the road on which the motor vehicle is traveling and of a global position at which the hazardous condition of the road exists.

An advantage of the present invention is that it may enable potholes and other road hazards to be rectified more quickly. Another advantage is that other drivers may be more quickly warned of the road hazard before it is rectified.

### BRIEF DESCRIPTION OF THE DRAWINGS

A better understanding of the present invention will be had upon reference to the following description in conjunction with the accompanying drawings.

FIG. 1 is a block diagram of one embodiment of a road hazard mitigation arrangement of the present invention.

FIG. 2 is a flow chart of one embodiment of a road hazard mitigation method of the present invention.

FIG. 3 is a flow chart of one embodiment of a method of the present invention for operating a motor vehicle.

### DETAILED DESCRIPTION OF THE PREFERRED EMBODIMENTS

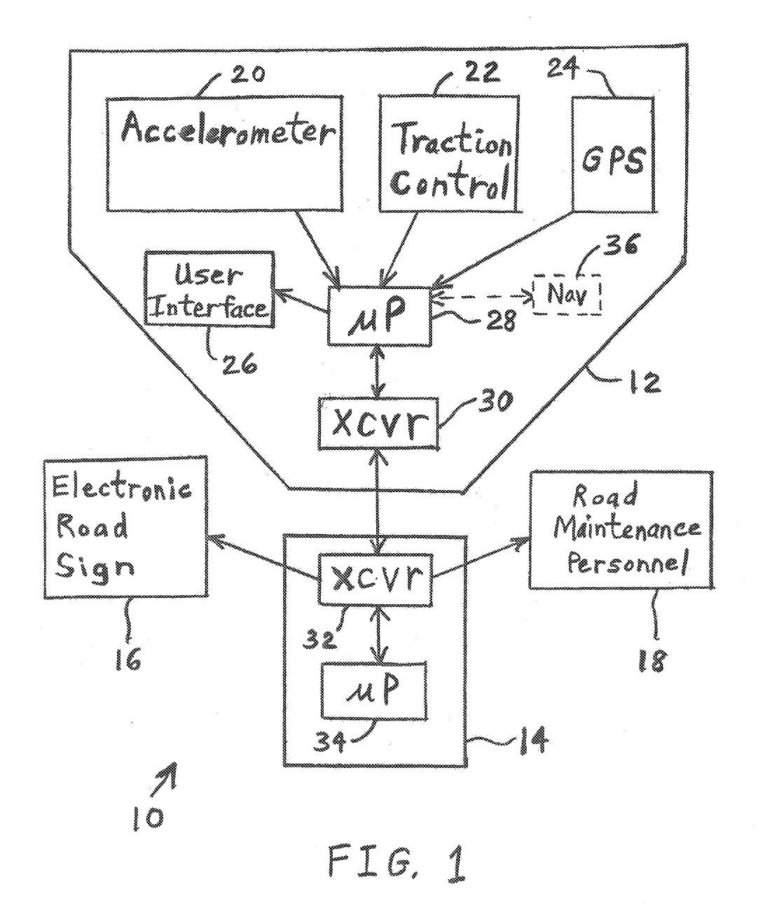

FIG. 1 illustrates one embodiment of a road hazard mitigation arrangement 10 of the present invention, including a vehicle 12, a governmental entity 14, an electronic road sign 16, and road maintenance personnel 18. Vehicle 12 includes an accelerometer 20, a traction control sensor 22, a global positioning system (GPS) 24, a user interface 26, an electronic processor 28, and a transceiver 30. Governmental entity 14 includes a transceiver 32 and an electronic processor 34.

During use, accelerometer 20 may sense a road hazard due to the abrupt movement of vehicle 12 in response to a tire of vehicle 12 falling into a pothole or rolling over an object lying in the road. Traction control sensor 22 may sense a road hazard due to a tire of vehicle 12 losing traction on an icy road surface. Regardless of the form of the road hazard, a sensor signal indicative of the road hazard is transmitted from accelerometer 20 or traction control sensor 22 to processor 28. GPS 24 may continually transmit the vehicle's global positioning coordinates to processor 28 such that processor 28 may determine and record the location of vehicle 12 when the road hazard is indicated to processor 28 by accelerometer 20 or traction control sensor 22. Processor 28 may cause transceiver 30 to wirelessly report the road hazard and its location to government entity 14. Processor 28 may also cause user interface 26 to present an indication to the driver, such as on a display screen of user interface 26, that the road hazard has been reported to government entity 14.

Transceiver 32 of government entity 14 may wirelessly receive the road hazard report from transceiver 30. Processor 34 of government entity 14 may receive the road hazard report from transceiver 32, analyze the report, and decide whether to cause electronic road sign 16 to display a warning message and/or dispatch road maintenance personnel 18 to fix the road hazard. Processor 34 may also transmit an acknowledgement signal to vehicle 12 via transceivers 30, 32, and processor 28 may indicate to the driver via user interface 26 that the acknowledgement signal has been received. Processor 34 may transmit a warning message to vehicle 12 and other vehicles within the broadcast range of transceiver 32, warning the drivers of the other vehicles of the reported road hazard. Processor 28 may cause the warning message from processor 34 to be presented to the driver via user interface 26. Similarly, the warning message may be presented to the drivers of the other vehicles within broadcast range. When processor 28 receives a warning message reported by another vehicle, vehicle 12 may decide not to present the warning message to the driver if the reported hazard is not on the planned route of vehicle 12, as determined by an optional navigation system 36 of vehicle 12, or if vehicle 12 is not scheduled to arrive at the road hazard within a certain (e.g., predetermined) period of time in the future (e.g., within five minutes from the current time). Vehicle 12 may also decide not to present the warning message to the driver if the reported hazard is not within a certain (e.g., predetermined) distance of vehicle 12.

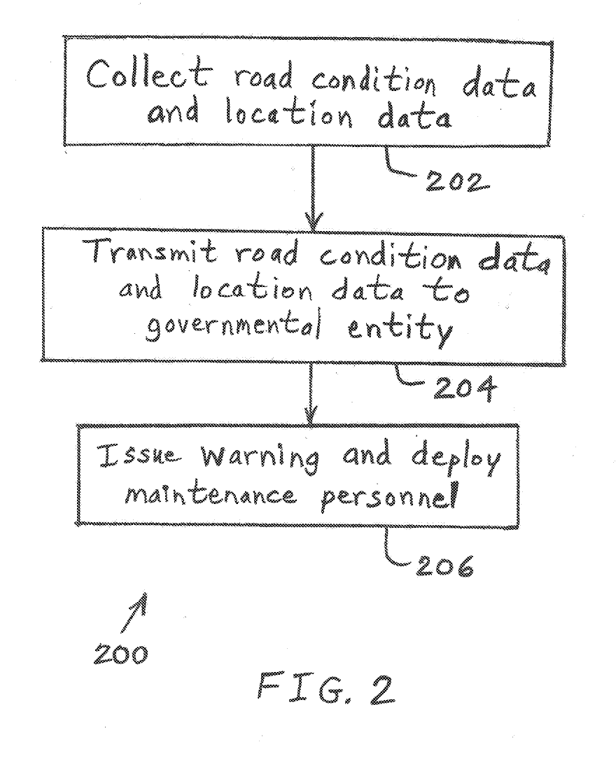

FIG. 2 illustrates one embodiment of a road hazard mitigation method 200 of the present invention. In a first step 202, road condition data and vehicle location data are collected. On-board sensor data, such as from one or more accelerometers, may be used to detect the signature of a pothole or road surface defect/condition. For example, accelerometer 20 and traction control sensor 22 may collect road condition data, and GPS module 24 may collect vehicle location data.

Next, in step 204, the road condition data and vehicle location data are wirelessly transmitted to a governmental entity. Raw sensor data or processed sensor meta data (in which the road condition signatures have been identified) may be wirelessly transmitted along with the location data. The wireless transmission may be a cellular transmission, a transmission via dedicated short range communications (DSRC), etc. For example, the data collected from accelerometer 20, traction control sensor 22 and GPS module 24 may be wirelessly transmitted from transceiver 30 to a transceiver of a governmental entity, such as to a local governmental entity like a county department of transportation (DOT), or to the U.S. Department of Transportation. The governmental entity may include a server database and infrastructure.

In a final step 206, a warning is issued and maintenance personnel are deployed. That is, a DOT entity may utilize this information to wirelessly transmit and issue warnings to other vehicles of impending situations/road hazards and deploy appropriate personnel to repair or resolve the road condition. For example, processor 34 may cause transceiver 32 to wirelessly transmit warnings of the reported road hazard to vehicles in the area of the road hazard, or within the broadcast range of transceiver 32, and these warnings may be presented to the drivers via a user interfaces of the drivers' vehicles. Processor 34 may also cause transceiver 32 to wirelessly transmit instructions to road maintenance personnel 18 to go to the location of the reported road hazard and rectify the road hazard.

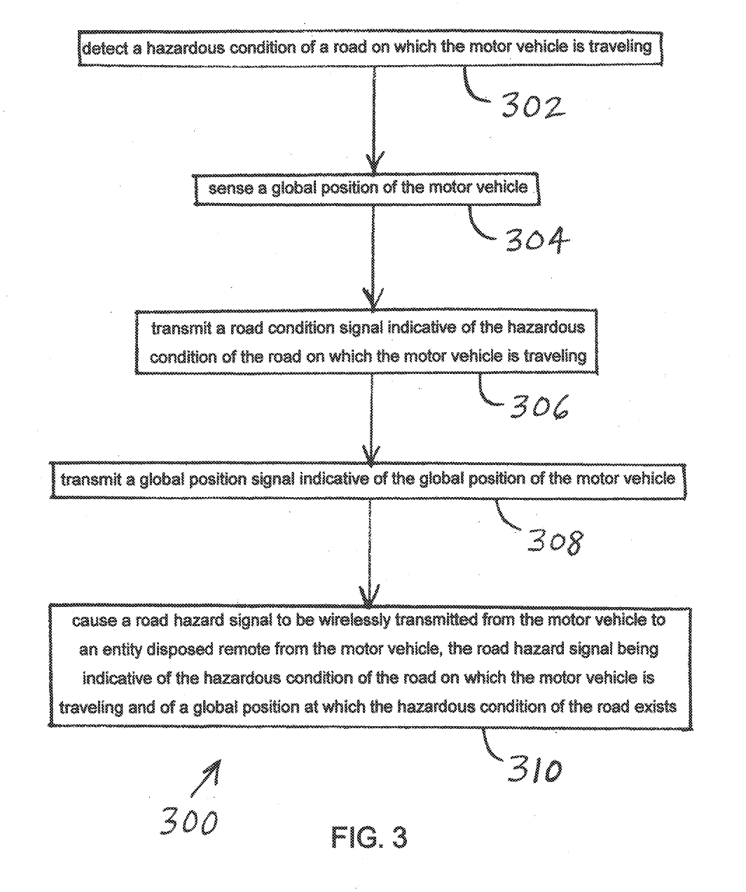

FIG. 3 illustrates one embodiment of a method 300 of the present invention for operating a motor vehicle. In a first step 302, a hazardous condition of a road on which the motor vehicle is traveling is detected. For example, accelerometer 20 may sense a road hazard due to the abrupt movement of vehicle 12 in response to a tire of vehicle 12 falling into a pothole or rolling over an object lying in the road, or traction control sensor 22 may sense a road hazard due to a tire of vehicle 12 losing traction on an icy road surface.

In a next step 304, a global position of the motor vehicle is sensed. For example, GPS 24 may continually determine the vehicle's global positioning coordinates.

Next, in step 306, a road condition signal indicative of the hazardous condition of the road on which the motor vehicle is traveling is transmitted. For example, a sensor signal indicative of the road hazard is transmitted from accelerometer 20 or traction control sensor 22 to processor 28.

In step 308, a global position signal indicative of the global position of the motor vehicle is transmitted. For example, GPS 24 may continually transmit the vehicle's global positioning coordinates to processor 28.

In a final step 310, a road hazard signal is caused to be wirelessly transmitted from the motor vehicle to an entity disposed remote from the motor vehicle, the road hazard signal being indicative of the hazardous condition of the road on which the motor vehicle is traveling and of a global position at which the hazardous condition of the road exists. For example, processor 28 may cause transceiver 30 to wirelessly report the road hazard and its location to government entity 14.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A motor vehicle, comprising:
a road condition sensor configured to detect a hazardous condition of a road on which the motor vehicle is traveling;
a global positioning system configured to detect a global position of the motor vehicle; and
an electronic processor communicatively coupled to the road condition sensor and to the global positioning sensor, the electronic processor being configured to:
receive a road condition signal from the road condition sensor, the road condition signal being indicative of the hazardous condition of the road on which the motor vehicle is traveling;
receive a global position signal from the global positioning sensor, the global position signal being indicative of the global position of the motor vehicle; and
cause a road hazard signal to be wirelessly transmitted to an entity disposed remote from the motor vehicle, the road hazard signal being indicative of the hazardous condition of the road on which the motor vehicle is traveling and of a global position at which the hazardous condition of the road exists.

2. The motor vehicle of claim 1 wherein the road condition sensor comprises an accelerometer.

3. The motor vehicle of claim 1 wherein the road condition sensor comprises a traction control sensor.

4. The motor vehicle of claim 1 wherein the hazardous condition comprises a pothole.

5. The motor vehicle of claim 1 wherein the hazardous condition comprises an object lying in the road.

6. The motor vehicle of claim 1 wherein the hazardous condition comprises a layer of ice on the road.

7. The motor vehicle of claim 1 further comprising a user interface communicatively coupled to the electronic processor, the electronic processor being configured to receive a road hazard warning signal from the remote entity and present a road hazard warning on the user interface, the road hazard warning being dependent upon the road hazard warning signal.

8. A method of operating a motor vehicle, the method comprising:
detecting a hazardous condition of a road on which the motor vehicle is traveling;
sensing a global position of the motor vehicle;
transmitting a road condition signal indicative of the hazardous condition of the road on which the motor vehicle is traveling;
transmitting a global position signal indicative of the global position of the motor vehicle; and
causing a road hazard signal to be wirelessly transmitted from the motor vehicle to an entity disposed remote from the motor vehicle, the road hazard signal being indicative of the hazardous condition of the road on which the motor vehicle is traveling and of a global position at which the hazardous condition of the road exists.

9. The method of claim 8 wherein the hazardous condition of the road is detected by an accelerometer.

10. The method of claim 8 wherein the hazardous condition of the road is detected by a traction control sensor.

11. The method of claim 8 wherein the hazardous condition comprises a pothole.

12. The method of claim 8 wherein the hazardous condition comprises an object lying in the road.

13. The method of claim 8 wherein the hazardous condition comprises a layer of ice on the road.

14. The method of claim 8 further comprising:
receiving within the motor vehicle a road hazard warning signal from the remote entity; and
presenting a road hazard warning on a user interface of the motor vehicle, the road hazard warning being dependent upon the road hazard warning signal.

15. A motor vehicle, comprising:
a road condition sensor configured to detect a hazardous condition of a road on which the motor vehicle is traveling;
a global positioning system configured to detect a global position of the motor vehicle; and
an electronic processor communicatively coupled to the road condition sensor and to the global positioning sensor, the electronic processor being configured to:
receive a road condition signal from the road condition sensor, the road condition signal being indicative of the hazardous condition of the road on which the motor vehicle is traveling;
receive a global position signal from the global positioning sensor, the global position signal being indicative of the global position of the motor vehicle; and
cause road hazard data to be wirelessly transmitted to an entity disposed remote from the motor vehicle, the road hazard data being indicative of the hazardous condition of the road on which the motor vehicle is traveling and of a global position at which the hazardous condition of the road exists.

16. The motor vehicle of claim 15 wherein the road condition sensor comprises an accelerometer.

17. The motor vehicle of claim 15 wherein the road condition sensor comprises a traction control sensor.

18. The motor vehicle of claim 15 wherein the hazardous condition comprises a pothole.

19. The motor vehicle of claim 15 wherein the hazardous condition comprises an object lying in the road.

20. The motor vehicle of claim 15 wherein the hazardous condition comprises a layer of ice on the road.

21. The motor vehicle of claim 15 further comprising a user interface communicatively coupled to the electronic processor, the electronic processor being configured to receive a road hazard warning signal from the remote entity and present a road hazard warning on the user interface, the road hazard warning being dependent upon the road hazard warning signal.
